(19) United States
(12) Patent Application Publication
(10) Pub. No.: US 2025/0332658 A1
(43) Pub. Date: Oct. 30, 2025

(54) ROBOTIC ADDITIVE AND SUBTRACTIVE HYBRID FORMING METHOD AND SYSTEM BASED ON MECHANOCHEMICAL EFFECTS

(71) Applicant: HARBIN INSTITUTE OF TECHNOLOGY, (SHENZHEN) (SHENZHEN INT'L TECHNICAL INNOVATION RESEARCH INSTITUTE), SHENZHEN (CN)

(72) Inventors: Yuchao BAI, SHENZHEN (CN); Yu YAN, SHENZHEN (CN); Bing LI, SHENZHEN (CN); Peng XU, SHENZHEN (CN)

(21) Appl. No.: 19/187,671

(22) Filed: Apr. 23, 2025

(30) Foreign Application Priority Data
Apr. 26, 2024 (CN) 202410513819.1

(51) Int. Cl. B23K 26/00; B23K 26/342

(52) U.S. Cl. CPC B23K 26/0093; B23K 26/342

(57) ABSTRACT

Disclosed is a robotic additive and subtractive hybrid forming method and system based on mechanochemical effects. The robotic additive and subtractive hybrid forming system includes a sealing device, an additive forming device, a coating device, a milling device, a tool stand, and a multi-axis manipulator. The multi-axis manipulator coats the surface of an additive deposition region of a workpiece with a metal surfactant using the coating device to significantly reduce the milling force and temperature to prolong the service life of a milling tool and improve the surface quality of a part, and then mill the additive deposition region coated with the metal surfactant using the milling device. The robotic additive and subtractive hybrid forming method and system based on mechanochemical effects effectively solve the problems of low production efficiency, short tool life, high production cost, and the like in an additive and subtractive hybrid manufacturing process.

### TECHNICAL FIELD

The present disclosure relates to the technical field of additive manufacturing, and in particular to a robotic additive and subtractive hybrid forming method and system based on mechanochemical effects.

### BACKGROUND

With the development of science and technology, additive manufacturing (AM) has been widely applied to aerospace, medical, automotive and military fields because parts formed by A M have the characteristics of complex structures, superior performance, etc.

At present, mainstream AM processes include powder bed fusion (PBF) and directed energy deposition (DED). Because of its ease in formation, PBF allows for a design according to the geometric shape rather than the volume to obtain structural strength with fewer materials and a lower weight and save raw materials at the same time, thus being suitable for formation of workpieces in a complex shape. However, the PBF process adopts relatively expensive powder and is low in forming efficiency and slow in shaping, thus not being suitable for large-scale formation and manufacturing. DED feeds raw materials onto a laser-, electric arc- or plasma beam-focused base plane by means of a powder or wire feed mechanism, the raw materials are molten to form a melt pool, and the melt pool, after being solidified, is connected to a formed portion to realize AM of a part; and a focused position may be moved to realize directed and sequential deposition of materials. The DED process is featured with high material utilization, flexible formation, and fixed-point deposition and restoration.

For example, Patent Publication No. CN110508809B discloses a forming system and method of hybrid additive manufacturing and surface coating. In this patent, surface peening treatment of a part is completed in a process of forming the part to be formed on an additive forming device layer by layer by means of a laser-assisted cold spraying device, such that the hybrid additive manufacturing and surface peening efficiency of the part is improved, and technical bottlenecks in direct hybrid additive manufacturing and surface coating for formation of parts with complex structures and high surface peening requirements are overcome. However, this patent is only targeted at the formation of soft materials. For the formation of hard powder materials, surface peening treatment performed by means of the laser-assisted cold spraying device will increase the work intensity of a milling and grinding compound device, thereby aggravating abrasion of a milling and grinding tool and increasing machining difficulty. In view of these problems, a milling fluid is used in a milling stage at present. Because of fluidity of the milling fluid, the milling fluid is easily diffused on the surface of a part to flow to a non-milling region and thus will be combined and react with raw materials and be combined with a formed portion in a next additive stage. Moreover, under a cooling effect of the milling fluid, the temperature of a melt pool may be decreased, and the raw materials fail to be completely molten, leading to defects in the formed part. Therefore, to prevent the milling fluid from flowing irregularly on the surface of the part to lower the risk of contaminating the part, dry milling is often adopted in the industry at present. However, in the dry milling process, due to a lack of lubricating and cooling effects of the milling fluid, a great milling force and a high temperature will be generated between a milling tool and the surface of a part, and the excessive milling force and temperature shorten the operating life of the milling tool and increase the production cost and the processing cycle of the whole workpiece.

### SUMMARY

To overcome one of the defects in the prior art, an objective of the present disclosure is to provide a robotic additive and subtractive hybrid forming method and system based on mechanochemical effects. The robotic additive and subtractive hybrid forming method and system based on mechanochemical effects solve the problems of low production efficiency, short tool life, and high production cost in an additive and subtractive hybrid manufacturing process.

To solve the abovementioned problems, the technical solution adopted by the present disclosure is as follows:

A robotic additive and subtractive hybrid forming method based on mechanochemical effects includes the following steps:
S100, plotting a workpiece model to be formed by means of 3D forming software, importing the formed workpiece model to computer-assisted software for slicing, then importing sliced workpiece model data to a control system, and presetting, by the control system, a forming trajectory, a metal surfactant coating trajectory, and a milling trajectory according to the workpiece model data;
S200, starting a vacuumizing device to vacuumize a sealing device, and when a vacuum degree in the sealing device satisfies a preset requirement, shutting down the vacuumizing device and starting a protective gas supply device to supply a protective gas; and when a gas pressure in the sealing device satisfies a preset requirement, shutting down the protective gas supply device and starting a cyclic cooling device at the same time;
S300, starting an additive forming device by the control system, and then depositing materials of a preset thickness in a preset region of a workpiece on a workbench according to a preset path;
S400, after the materials deposited on the workpiece are cooled or a melt pool is solidified, controlling a multi-axis manipulator to move onto a tool stand and be connected to a coating device by means of a first quick-change structure, and then synchronously driving the multi-axis manipulator and the coating device to coat the region, deposited with the materials, of the workpiece on the workbench with a metal surfactant according to the present metal surfactant coating trajectory; and after the workpiece is coated with the metal surfactant, controlling, by the control system, the multi-axis manipulator to unload the coating device and place the coating device back onto the tool stand;
S500, controlling, by the control system, the multi-axis manipulator to be connected to a milling device by means of the first quick-change structure, and at the same time, controlling the multi-axis manipulator and the milling device to mill the region, coated with the metal surfactant, of the workpiece according to the milling trajectory; and after the region coated with the metal surfactant is milled, controlling, by the control system, the multi-axis manipulator to unload the milling device and place the milling device back onto the tool stand; and
S600, repeating steps S300-S500 until the workpiece is formed.

In some possible embodiments, components in the metal surfactant include, in percentage by mass, 10-15% of carbon black, 50-60% of diacetone alcohol, and 20-30% of propylene glycol monomethyl ether.

A robotic additive and subtractive hybrid forming system based on mechanochemical effects includes:
a sealing device, internally provided with a sealed space, a workbench with an adjustable spatial position being arranged in the sealed space, and the workbench being configured for clamping and fixing a workpiece to be fabricated;
an additive forming device, arranged in the sealed space and configured for performing additive deposition on a surface of a region to be fabricated of the workpiece;
a coating device;
a milling device;
a tool stand, arranged in the sealed space and configured for storing the milling device and the coating device; and
a multi-axis manipulator, mounted in the sealed space, an operating end of the multi-axis manipulator being adaptive to the milling device and the coating device by means of a first quick-change structure, and the multi-axis manipulator being able to coat a surface of an additive deposition region of the workpiece with a metal surfactant by means of the coating device and mill the additive deposition region coated with the metal surfactant by means of the milling device.

In some possible embodiments, the coating device includes a base, a second quick-change structure adaptive to the first quick-change structure is arranged on the base, a storage space is formed in the base and is communicated with a supply device for supplying the metal surfactant, a loading tube is arranged on the base, a scraping plate is arranged at one end of the loading tube, a plurality of discharge outlets are formed in a side surface of one end of the scraping plate away from the loading tube, and all the discharge outlets are communicated with the storage device by means of the loading tube.

In some possible embodiments, an arc-shaped contact coating surface is arranged on an edge of one end of the scraping plate close to the discharge outlets.

In some possible embodiments, the supply device includes a metal surfactant reservoir, a feed tube with one end communicated with the metal surfactant reservoir, and the other end communicated with the storage space, and a feed pump arranged on the feed tube.

In some possible embodiments, the additive forming device includes an additive multi-axis robotic arm, a cladding head, a metal wire/powder storage device, and a wire/powder feed mechanism. The additive multi-axis robotic arm is mounted in the sealed space, the cladding head is mounted at an operating end of the additive multi-axis robotic arm, the additive multi-axis robotic arm is able to drive the cladding head to perform fused deposition on the workpiece on the workbench, the metal wire/powder storage device is communicated with an input end of the wire/powder feed mechanism, and an output end of the wire/powder feed mechanism is communicated with the cladding head.

In some possible embodiments, a vacuumizing device, a protective gas supply device and a cyclic cooling device are communicated with the sealing device.

In some possible embodiments, the robotic additive and subtractive hybrid forming system based on mechanochemical effects further includes a control system electrically connected to the additive forming device, the coating device, the milling device, and the multi-axis manipulator.

Compared with the prior art, the present disclosure has the following beneficial effects.

According to the robotic additive and subtractive hybrid forming method and system based on mechanochemical effects provided by the present disclosure, the multi-axis manipulator is designed to adapt to the milling device and the coating device by means of the first quick-change structure, such that the use cost and occupied space are reduced, and the complexity of the whole control system is reduced, thus reducing the equipment cost. The coating device is configured for coating a formed part with a metal surfactant, such that the milling force and temperature are significantly reduced, thereby prolonging the service life of a milling tool and improving the surface quality of the part. Moreover, the fluidity of the metal surfactant is poor, such that the additive environment will not be polluted, thereby guaranteeing the additive quality of the part.

### BRIEF DESCRIPTION OF THE DRAWINGS

To more clearly explain the technical solutions in the embodiments of the present disclosure, drawings used for describing the embodiments of the present disclosure are briefly introduced below. Obviously, the drawings described below merely illustrate some embodiments of the present disclosure, and those ordinarily skilled in the art may obtain other drawings according to the following ones without creative effort.

FIG. 1 is a schematic structural diagram according to one embodiment of the present disclosure;

FIG. 2 is a partial schematic structural diagram of a coating device according to one embodiment of the present disclosure;

FIG. 3 is a curve graph of milling force in the presence and absence of a metal surfactant according to one embodiment of the present disclosure; and

FIG. 4 is a corroborative operation diagram of an additive process, a coating process, and a milling process according to one embodiment of the present disclosure.

### REFERENCE NUMERALS

10, sealing device; 11, sealed space; 12, workbench;
20, additive forming device; 21, additive multi-axis robotic arm; 22, cladding head; 23, metal wire/powder storage device; 24, wire/powder feed mechanism;
30, coating device; 31, base; 32, second quick-change structure; 33, loading tube; 34, scraping plate; 35, discharge outlet; 36, contact coating surface; 37, metal surfactant reservoir; 38, feed tube; 39, feed pump;
40, milling device;
50, tool stand;
60, multi-axis manipulator; 61, first quick-change structure;
70, control system.

### DETAILED DESCRIPTION OF THE EMBODIMENTS

The technical solutions in the embodiments of the present disclosure are clearly and completely described below in conjunction with accompanying drawings in the embodiments of the present disclosure. Obviously, the embodiments described are merely a part rather than all the embodiments of the present disclosure. All other embodiments obtained by those ordinarily skilled in the art based on the embodiments of the present disclosure without creative effort should also fall within the protection scope of the present disclosure.

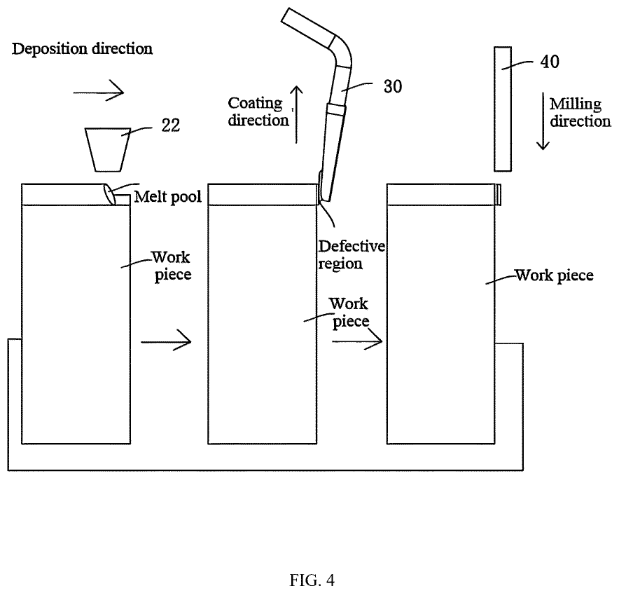

Referring to FIG. 4, a robotic additive and subtractive hybrid forming method and system based on mechanochemical effects includes the following steps:
S100, a workpiece model to be formed is plotted by means of 3D forming software, the formed workpiece model is imported to computer-assisted software for slicing, then sliced workpiece model data are imported to a control system, and the control system presets a forming trajectory, a metal surfactant coating trajectory, and a milling trajectory according to the workpiece model data;
S200, a vacuumizing device is started to vacuumize a sealing device 10, and when a vacuum degree in the sealing device 10 satisfies a preset requirement, the vacuumizing device is shut down, and a protective gas supply device is started to supply a protective gas; and when a gas pressure in the sealing device 10 satisfies a preset requirement, the protective gas supply device is shut down, and a cyclic cooling device is started at the same time;
S300, an additive forming device 20 is started by the control system, and then materials of a preset thickness are deposited in a preset region of a workpiece on a workbench 12 according to a preset path;
S400, after the materials deposited on the workpiece are cooled or a melt pool is solidified, a multi-axis manipulator 60 is controlled to move onto a tool stand 50 and is connected to a coating device 30 by means of a first quick-change structure 61, and then the multi-axis manipulator 60 and the coating device 30 are synchronously driven to coat the region, deposited with the materials, of the workpiece on the workbench 12 with a metal surfactant according to the metal surfactant coating trajectory; and after the workpiece is coated with the metal surfactant, the control system controls the multi-axis manipulator 60 to unload the coating device 30 and place the coating device 30 back onto the tool stand 50;
S500, the control system controls the multi-axis manipulator 60 to be connected to a milling device 40 by means of the first quick-change structure 61, and at the same time, the multi-axis manipulator 60 and the milling device 40 are controlled to mill the region, coated with the metal surfactant, of the workpiece according to the milling trajectory; and after the region coated with the metal surfactant is milled, the control system controls the multi-axis manipulator 60 to unload the milling device 40 and place the milling device 40 back onto the tool stand 50; and
S600, steps S300-S500 are repeated until the workpiece is formed.

In step S100, the 3D forming software may be Solidworks or UG, part slicing software is also conventional software, and the operating principle of the software will not be detailed here by the applicant. Construction and slicing of the 3D model are conventional technical means and will not be detailed herein. In step S200, if the gas pressure in the sealing device 10 is decreased, or a gas in the sealing device 10 is changed in the additive manufacturing process, the protective gas supply device needs to be shut down, and step S200 is repeated until the gas pressure in the sealing device 100 satisfies the preset requirement.

In the above embodiment, to weaken material strength of the region to be coated, components in the metal surfactant include, in percentage by mass, 10-15% of carbon black, 50-60% of diacetone alcohol, and 20-30% of propylene glycol monomethyl ether. In this embodiment, after the surface of the workpiece is coated with the metal surfactant, organic polar molecules of the metal surfactant will be adsorbed on the surface of the workpiece, which prevents atoms in a shear region from moving towards free surfaces of chips along a shear surface in a cutting process to promote accumulation of distortion and leads to stress concentration of a first cut region to form micro-cracks; and as a result, the chips become embrittled to promote removal of the chips, thus preventing the chips from being accumulated on a front surface of a tool.

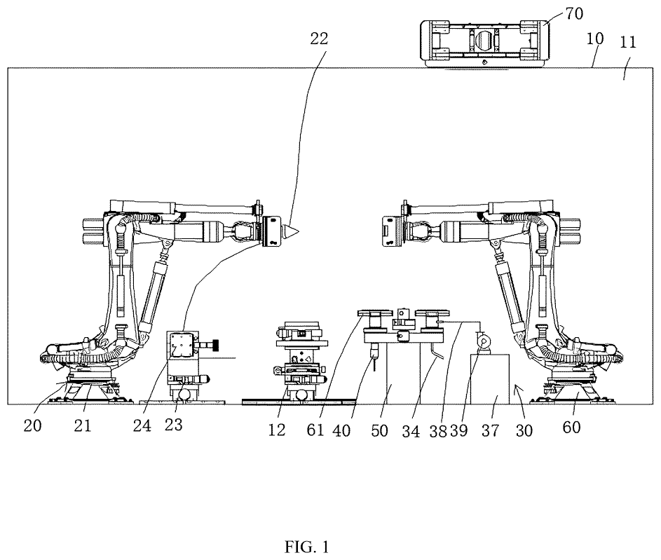

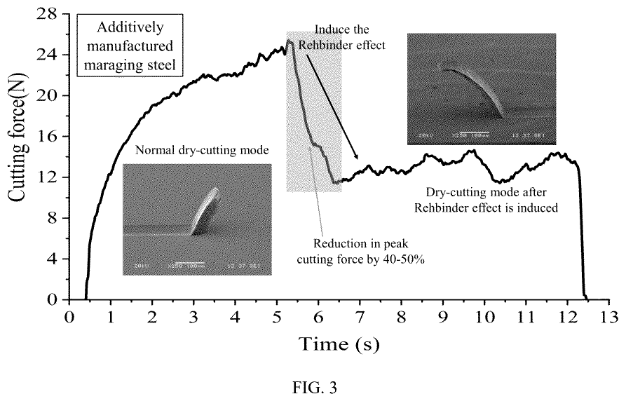

Referring to FIGS. 1-4, a robotic additive and subtractive hybrid forming system based on mechanochemical effects includes a sealing device 10, an additive forming device 20, a coating device 30, a milling device 40, a tool stand 50, and a multi-axis manipulator 60. A sealed space 11 is formed in the sealing device 10, a workbench 12 with an adjustable spatial position is arranged in the sealed space 11, and the workbench 12 is configured for clamping and fixing a workpiece. The additive forming device 20 is arranged in the sealed space 11 and configured for performing additive deposition on a surface of a region to be fabricated of the workpiece. The tool stand 50 is arranged in the sealed space 11 and configured for storing the milling device 40 and the coating device 30. The multi-axis manipulator 60 is mounted in the sealed space 11, an operating end of the multi-axis manipulator 60 is adaptive to the milling device 40 and the coating device 30 by means of a first quick-change structure 61, the multi-axis manipulator 60 is able to coat a surface of an additive deposition region of the workpiece with a metal surfactant by means of the coating device 30 and mill the additive deposition region coated with the metal surfactant by means of the milling device 40.

The multi-axis manipulator 60 is a multi-degree-of-freedom manipulator, is a common technical solution, and thus will not be detailed here by the applicant. The first quick-change structure 61 may be a quick-change tool for a milling machine disclosed by Patent Publication No. CN219746453U and will not be detailed here by the applicant. It should be additionally noted that the first quick-change structure 61 adopts a split-type design, where one portion of the first quick-change structure 61 is arranged on the milling device 40, one portion of the quick-change structure 61 is arranged on the coating device 30, and another portion of the quick-change structure 61 is arranged on the multi-axis manipulator 60, such that flexibility in use may be improved. The milling device 40 in the present disclosure may be a conventional quick-change milling tool head, and the coating device 30 is also in a conventional structural design and may adopt a semi-fluid coating method. In the present disclosure, the tool stand 50 may be a quick-change tool magazine and is mainly used for storing the milling device 40 and the coating device 30.

According to the robotic additive and subtractive hybrid forming method and system based on mechanochemical effects, the multi-axis manipulator 60 is designed to adapt to the milling device 40 and the coating device 30 by means of the first quick-change structure 61, such that the use cost and occupied space are reduced, and the complexity of the whole control system is reduced, thus reducing the equipment cost. The coating device 30 is configured for coating the formed part with the metal surfactant, such that a milling force and temperature are significantly reduced, thereby prolonging the service life of a milling tool and improving the surface quality of the part. Moreover, the fluidity of the metal surfactant is poor, such that the additive environment will not be polluted, thereby guaranteeing additive quality of the part.

In some possible embodiments, referring to FIG. 1, the additive forming device 20 includes an additive multi-axis robotic arm 21, a cladding head 22, a metal wire/powder storage device 23, and a wire/powder feed mechanism 24. The additive multi-axis robotic arm 21 is mounted in the sealed space 11, the cladding head 22 is mounted at an operating end of the additive multi-axis robotic arm 21, the additive multi-axis robotic arm 21 is able to drive the cladding head 22 to perform fused deposition on the workpiece on the workbench 12, the metal wire/powder storage device 23 is communicated with an input end of the wire/powder feed mechanism 24, and an output end of the wire/powder feed mechanism 24 is communicated with the cladding head 22. If metal powder is adopted in the present disclosure, the metal wire/powder storage device 23 is a storage tank; and if a metal wire is adopted, the metal wire/powder storage device 23 is a metal reel. Similarly, the wire/powder feed mechanism 24 may be a powder supply pump or a clamping structure according to properties of materials used in the present disclosure. It should be noted that the additive forming device 20 is a conventional technical solution and will not be detailed herein.

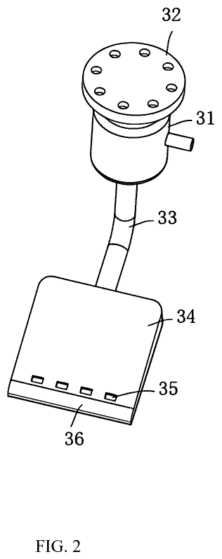

In some possible embodiments, referring to FIGS. 1 and 2, to realize accurate coating of the metal surfactant, the coating device 30 includes a base 31, a second quick-change structure 32 adaptive to the first quick-change structure 61 is arranged on the base 31, a storage space is formed in the base 31 and is communicated with a supply device for supplying the metal surfactant, a loading tube 33 is arranged on the base 31, a scraping plate 34 is arranged at one end of the loading tube 33, a plurality of discharge outlets 35 are formed in a side surface of one end of the scraping plate 34 away from the loading tube 33, and all the discharge outlets 35 are communicated with the storage space by means of the loading tube 33. The second quick-change structure 32 may be construed as one portion of the first quick-change structure 61 and used together with a main portion of the first quick-change structure to realize quick connection and fixation. The supply device may adopt a pipeline to supply the metal surfactant to prevent interference between the multi-axis manipulator 60 and the workpiece in moving the multi-axis manipulator. In the present disclosure, a pipeline adopted by the supply device may be fixed to the multi-axis manipulator 60 by means of a fixing structure. In addition, the loading tube 33 and the scraping plate 34 may be connected in a non-coplanar manner, that is, the loading tube 33 and the scraping plate 34 are bent relative to each other. In this way, the end, close to the discharge outlets 35, of the scraping plate 34 more easily stretches into a region to be coated of the workpiece.

In some possible embodiments, to facilitate the contact between the scraping plate 34 and the surface of the workpiece, an arc-shaped contact coating surface 36 is arranged on an edge of one end of the scraping plate 34 close to the discharge outlets 35.

In some possible embodiments, referring to FIG. 1, to facilitate the supply of the metal surfactant, the supply device includes a metal surfactant reservoir 37, a feed tube 38 with one end communicated with the metal surfactant reservoir 37 and the other end communicated with the storage space, and a feed pump 39 arranged on the feed tube 38. The feed tube 38 may be fixed to the multi-axis manipulator 60 by means of a tie or a hasp. It should be noted that to realize automatic supply of the metal surfactant, a position sensor is arranged on the contact coating surface 36. When the contact coating surface 36 comes into contact with the surface of the workpiece, the position sensor controls the feed pump 39 to supply the metal surfactant, such that the metal surfactant will not be supplied too early or late.

In some possible embodiments, referring to FIG. 1, a vacuumizing device, a protective gas supply device, and a cyclic cooling device are communicated with the sealing device 10. The vacuumizing device may be a conventional structure formed by a vacuum pump and a pipeline, one end of the pipeline is communicated with the sealing device 10, and a check valve is arranged on the pipeline. The protective gas supply device includes a gas tank, a supply pump, a gas supply tube, and a mating valve body arranged on the gas supply tube, the gas supply tube has one end connected to the gas tank and the other end of the gas supply tube connected to the sealing device 10, and the supply pump and the valve body are both arranged on the gas supply tube. The cyclic cooling device includes a circulating tube and a circulating pump arranged on the circulating tube, two ends of the circulating tube both are communicated with the sealing device 10, and at least part of the circulating tube is connected to an external water-cooled heat exchanger.

In some possible embodiments, referring to FIG. 1, to realize intelligent control, the robotic additive and subtractive hybrid forming system based on mechanochemical effects of the present disclosure further includes a control system 70 electrically connected to the additive forming device 20, the coating device 30, the milling device 40, and the multi-axis manipulator 60. The control system 70 may be a conventional programmable control system or an end surface milling control system in Patent Publication No. CN107791099A and will not be detailed here by the applicant.

The above description is merely used to explain the specific implementation of the present disclosure and is not intended to limit the protection scope of the present disclosure. Any variations or substitutions made according to the technical contents of the present disclosure should also fall within the protection scope of the present disclosure. Therefore, the protection scope of the present disclosure should be defined by the claims.

1. A robotic additive and subtractive hybrid forming method based on mechanochemical effects, comprising the following steps:
S100, plotting a workpiece model to be formed by means of 3D forming software, importing the formed workpiece model to computer-assisted software for slicing, then importing sliced workpiece model data to a control system, and presetting, by the control system, a forming trajectory, a metal surfactant coating trajectory, and a milling trajectory according to the workpiece model data;
S200, starting a vacuumizing device to vacuumize a sealing device, and when a vacuum degree in the sealing device satisfies a preset requirement, shutting down the vacuumizing device and starting a protective gas supply device to supply a protective gas; and when a gas pressure in the sealing device satisfies a preset requirement, shutting down the protective gas supply device and starting a cyclic cooling device at the same time;
S300, starting an additive forming device by the control system, and then depositing materials of a preset thickness in a preset region of a workpiece on a workbench according to a preset path;
S400, after the materials deposited on the workpiece are cooled or a melt pool is solidified, controlling a multi-axis manipulator to move onto a tool stand and be connected to a coating device by means of a first quick-change structure, and then synchronously driving the multi-axis manipulator and the coating device to coat the region, deposited with the materials, of the workpiece on the workbench with a metal surfactant according to the metal surfactant coating trajectory; and after the workpiece is coated with the metal surfactant, controlling, by the control system, the multi-axis manipulator to unload the coating device and place the coating device back onto the tool stand;
S500, controlling, by the control system, the multi-axis manipulator to be connected to a milling device by means of the first quick-change structure, and at the same time, controlling the multi-axis manipulator and the milling device to mill the region, coated with the metal surfactant, of the workpiece according to the milling trajectory; and after the region coated with the metal surfactant is milled, controlling, by the control system, the multi-axis manipulator to unload the milling device and place the milling device back onto the tool stand; and
S600, repeating steps S300-S500 until the workpiece is formed.

2. The robotic additive and subtractive hybrid forming method based on mechanochemical effects according to claim 1, wherein components in the metal surfactant comprise, in percentage by mass, 10-15% of carbon black, 50-60% of diacetone alcohol, and 20-30% of propylene glycol monomethyl ether.

3. A robotic additive and subtractive hybrid forming system based on mechanochemical effects, capable of implementing the robotic additive and subtractive hybrid forming system according to claim 1, comprising:
a sealing device, internally provided with a sealed space, a workbench with an adjustable spatial position being arranged in the sealed space, and the workbench being configured for clamping and fixing a workpiece to be fabricated;
an additive forming device, arranged in the sealed space and configured for performing additive deposition on a surface of a region to be fabricated of the workpiece;
a coating device;
a milling device;
a tool stand, arranged in the sealed space and configured for storing the milling device and the coating device; and
a multi-axis manipulator, mounted in the sealed space, an operating end of the multi-axis manipulator being adaptive to the milling device and the coating device by means of a first quick-change structure, and the multi-axis manipulator being able to coat a surface of an additive deposition region of the workpiece with a metal surfactant by means of the coating device and mill the additive deposition region coated with the metal surfactant by means of the milling device.

4. The robotic additive and subtractive hybrid forming system based on mechanochemical effects according to claim 3, wherein the coating device comprises a base, a second quick-change structure adaptive to the first quick-change structure is arranged on the base, a storage space is formed in the base and is communicated with a supply device for supplying the metal surfactant, a loading tube is arranged on the base, a scraping plate is arranged at one end of the loading tube, a plurality of discharge outlets are formed in a side surface of one end of the scraping plate away from the loading tube, and all the discharge outlets are communicated with the storage device by means of the loading tube.

5. The robotic additive and subtractive hybrid forming system based on mechanochemical effects according to claim 4, wherein an arc-shaped contact coating surface is arranged on an edge of one end of the scraping plate close to the discharge outlets.

6. The robotic additive and subtractive hybrid forming system based on mechanochemical effects according to claim 4, wherein the supply device comprises a metal surfactant reservoir, a feed tube with one end communicated with the metal surfactant reservoir and the other end communicated with the storage space, and a feed pump arranged on the feed tube.

7. The robotic additive and subtractive hybrid forming system based on mechanochemical effects according to claim 3, wherein the additive forming device comprises an additive multi-axis robotic arm, a cladding head, a metal wire/powder storage device, and a wire/powder feed mechanism, the additive multi-axis robotic arm is mounted in the sealed space, the cladding head is mounted at an operating end of the additive multi-axis robotic arm, the additive multi-axis robotic arm is able to drive the cladding head to perform fused deposition on the workpiece on the workbench, the metal wire/powder storage device is communicated with an input end of the wire/powder feed mechanism, and an output end of the wire/powder feed mechanism is communicated with the cladding head.

8. The robotic additive and subtractive hybrid forming system based on mechanochemical effects according to claim 3, wherein a vacuumizing device, a protective gas supply device and a cyclic cooling device are communicated with the sealing device.

9. The robotic additive and subtractive hybrid forming system based on mechanochemical effects according to claim 3, further comprising a control system electrically connected to the additive forming device, the coating device, the milling device, and the multi-axis manipulator.
